(19) United States
(12) Patent Application Publication
(10) Pub. No.: US 2012/0143636 A1
(43) Pub. Date: Jun. 7, 2012

(54) FINAL SALE MERCHANDISE CARD

(76) Inventor: Bertram V. Burke, Sarasota, FL (US)

(21) Appl. No.: 13/369,274

(22) Filed: Feb. 8, 2012

Related U.S. Application Data
(63) Continuation of application No. 12/405,810, filed on Mar. 17, 2009, now abandoned.
Application No. 12/405,810 is a continuation-in-part of application No. 11/582,603, filed on Oct. 18, 2006, now abandoned.
Application No. 11/582,603 is a continuation of application No. 10/823,850, filed on Apr. 14, 2004, now Pat. No. 7,264,153.
(60) Provisional application No. 60/462,732, filed on Apr. 14, 2003.

(51) Int. Cl. G06Q 40/08

(52) U.S. Cl. 705/4

(57) ABSTRACT

A system and method that involves a merchant, a merchandise cardholder, and a beneficiary that allows a customer to select one or more beneficiaries that are to own any unused proxy sale merchandise, associating the one or more default beneficiaries with the customer merchandise account, wherein the one or more default beneficiaries differs from the customer, the customer merchandise account having a remaining balance of merchandise owned by the customer and automatically converting an amount of the customer owned proxy sold merchandise based on a conversion date, to ownership by the beneficiary; and transferring ownership of the proxy sold merchandise to the selected one or more beneficiaries.

### CROSS-REFERENCE TO RELATED APPLICATIONS

The present application is a Continuation-in-Part of Continuation patent application Ser. No. 11/582,603, filed Oct. 18, 2006, which claims the benefit of patent application Ser. No. 10/823,850, filed Apr. 14, 2004, now U.S. Pat. No. 7,264,153, which application is related to and claims priority from U.S. Provisional Patent Application Ser. No. 60/462,732, filed Apr. 14, 2003, by Bertram Burke, entitled FINAL SALE MERCHANDISE CARD, the entirety of all of which is incorporated herein by reference.

### FIELD OF THE INVENTION

This invention relates to a customer purchased merchandised card.

### BACKGROUND OF THE INVENTION

In 2003 consumers purchased $45 billion in stored value card (SVC) credits from card issuers who are retailers, mall offices, banks, card associations, and travel service providers. In the marketplace SVC are commonly referred to as gift, prepaid, or traveler's money card programs.

The majority of SVC issuers provide consumers with mag strip cards that are connected to a host-client network system. Consumers use their cards to initially load and reload merchandise at remote terminals, e.g. cash registers, POS terminals, Internet web site POS terminals, etc.

After value has been added to a SVC, consumers use their card to make purchases for goods and/or services at (a) merchants who issue cards (a “closed” loop system) or (b) banks who issue cards and provide cardholders with the opportunity to use their cards at multiple and diverse merchants (an “open” system).

In return for selling and reloading SVCs, merchants have benefited by consumers spending more than the face value of the card, the float on the money held in their SVC account until the merchandise are debited, and the “breakage” amount that occurs when customers abandon 10 to 15% of the merchandise that they deposited into a SVC account.

When banks sell SVC cards, they benefit from charging customers loading fees on the amount of merchandise they deposit, float fees on the merchandise maintained in the accounts, and interchange fees when customers make purchases at participating merchants or use ATM machines for cash.

Along with the outstanding success that merchants and banks are gaining from offering the current SVC programs, they are also experiencing the following problems (a) Consumers do not own any merchandise or services when they purchase SVC credits; therefore, if an issuer goes out of business or becomes insolvent, the consumers loses the merchandise they deposited into their SVC merchandise. (b) When issuers accept SVC merchandise, they cannot be recorded as an immediate sale; therefore, the issuer cannot report the transaction as revenue. (c) Issuers have to wait until cardholders debit their accounts before they can declare any revenue. (d) The “breakage” amount that occurs when customers abandon 10 to 15% of the merchandise, has until recently been the property of the issuer. Now issuers are being challenged by state treasuries, invoking existing “unclaimed property laws”, to turn over the merchandise to the state. As the impact of this process expands, it is entirely possible that merchants will lose all rights to the “breakage” merchandise that they were formerly able to keep. (e) Furthermore, with the introduction of state treasuries in the mix, issuers are now being required to maintain costly SVC accounting records and conduct audits for yearly reporting to the respective state treasuries. (f) In order to deal with the growing elimination of “breakage” merchandise, issuers have attempted to put expiration dates on their SVCs. As a result of this very unpopular tactic, a growing number of states have outlawed issuers from using expiration dates for SVCs. and (g) As another way to recoup from losing “breakage” merchandise, issuers have also instituted monthly charges (avg. $2.50) when SVC accounts are not being used. In response to this compensatory initiative, again a growing number of states have passed laws blocking issuers from charging non-user fees.

In analyzing the above cited problems, it is obvious there are two major limitations within the current SVC system. They are (a) issuers accept merchandise from consumers with the expectation that they have made a sale and (b) consumers turn over merchandise to issuers with the understanding they now own some merchandise or services, for themselves or as a gift for others.

However, in reality, both parties do not receive what they want. The fact is issuers are really selling “financial credits” to consumers for future ownership of goods or services.

In the future, such “credits” can then be exchanged for merchant supplied goods and services. Consequently, under the current system, merchants do not have a sale until the customer cashes the “credits” in for goods and services. Therefore, as it now stands, merchants do not have any guarantee that there will ever be a sale.

Under the current system merchants have to wait until the customer redeems the financial credits for goods or services. Only at that time does a merchant have reportable revenue from their growing sales of gift, prepaid, or traveler's money cards. As a result of the delay in timing, merchants are increasingly being forced to under report what they think are their legitimate sales. By increasingly under reporting their sales, merchants now are asking the question: “Will this phenomenon, have a negative impact on their corporate earnings, valuations, and the price of their company's stock?”

Now, after a time of nonuse, some states are viewing the remaining balances in SVCs as being “unclaimed property”. Under such a declaration, state treasuries can implement escheat laws and require issuers to surrender the unused merchandise to the respective state treasuries.

Once “unclaimed property” laws are called to action—customers, issuers, city and state sale tax authorities, and the Internal Revenue Service—all will lose the rights to the merchandise that issuers and consumers—upfront agreed—to be used to conveniently purchase goods and services.

Accordingly, in light of the above, it would be advantageous to improve the existing gift, prepaid, traveler's money cards so that once merchandise are entered into the system there is an immediate and recognizable sale of goods or services. Once this occurs, each of the above cited problem factors (“a” through “g”) by definition and classification are eliminated from occurring. The method and system that can provide order and purpose to this payment option is a merchandise card.

U.S. Pat. No. 7,264,153, issued to the inventor of the subject matter of this application, solves the aforementioned issues (“a” through “g”) by allowing merchants to sell a percentage of their inventory to customers, therefore transferring ownership to the customer, thus resulting in a final sale of goods or services via the issuance of a merchandise card.

However, there remains a problem when customers do not take physical possession of 100% of the merchandise that they have purchased under the FINAL SALE MERCHANDISE CARD.

It is the intention of this application to provide order and purpose to the open issue of what to do with any leftover merchandise.

### SUMMARY OF THE INVENTION

An embodiment of the invention allows consumers to enter cash value into a merchandise card account and immediately have the issuer record the transaction as revenue from a sale of goods and/or services.

According to another embodiment of the invention, merchants or issuers will be able to convert the cash value entered into a merchandise card account—into a sale of proxy merchandise—after they calculate and report the average historical costs associated with the merchant's or issuer's inventory. The merchant's or issuer's costs to be considered would be (1) the applicable city, state, federal taxes and (2) the cost of the sold goods and overhead. Within this embodiment, at the time of the proxy purchase, cardholders will be buying a percentage of the merchant's or issuer's inventory. While making the purchase, under the terms of the merchandise card, the merchant or issuer agrees to hold and store the purchased inventory until the cardholders make a final inventory selection.

According to another embodiment of the invention, at a later time cardholders will be able to reconfigure and exchange the initial sale of proxy merchandise for other goods or services. The final selection of merchandise or services selected by the cardholder will then be recalculated by the invention to determine (1) the applicable city, state, federal taxes and (2) the cost of the sold goods and overhead related to the final merchandise selected by the cardholder. Effectively, once the final selection of inventory occurs, the final transaction log will replace whatever percentage of the initial proxy purchase was used up. Also, at time of the final purchase, cardholders will take the purchased inventory items away from the merchant's location.

According to another embodiment of the invention, in the event that merchants or issuers go bankrupt or become insolvent, the invention will be able to provide the court with records indicating the percentage of the merchant's or issuer's inventory that is owned by the merchandise cardholders. Once this occurs the court will have the needed knowledge to instruct the merchant, issuer, or trustee how much of the existing inventory should be made available to the existing merchandise cardholders. The court could then instruct the party in charge to set up clamming sites whereupon the merchandise cardholder will be able to select from available inventory.

According to another embodiment, the invention involves a merchant, a merchandise cardholder, and a beneficiary that provides a method for selecting one or more beneficiaries that are to own any unused proxy sale merchandise, the merchandise being issued by the merchant, associating the one or more default beneficiaries with the customer merchandise account, wherein the one or more default beneficiaries differs from the customer, the customer merchandise account having a remaining balance of merchandise owned by the customer and automatically converting an amount of the customer owned proxy sold merchandise based on a trigger parameter, set at the time of the sale or reloading of the merchandise card. Said conversion of ownership of inventory will be assigned to the new owner/beneficiary.

According to another embodiment, a system for converting customer owned merchandise is provided. The system includes a database for associating one or more beneficiaries with a merchandise card account, the one or more beneficiaries selected by the cardholder, wherein the one or more beneficiaries differs from the merchant cardholder, the merchandise card account having a remaining balance of merchandise owned by the cardholder; a storage device for storing a trigger parameter; and at least one processor for determining when to automatically convert an amount of the remaining merchandise based on the triggering parameter and for transferring ownership of the merchandise to the one or more beneficiaries wherein the converting comprises recording by a merchant of the amount of merchandise being donated to the new owner.

According to another embodiment, it is therefore an object of the present invention to provide a system and method to transfer ownership of leftover “proxy sold” merchandise previously purchased by an original customer to the ownership of one or more “beneficiaries”.

It is also another object of the invention, in the event that if the original customer does not select one or more “beneficiaries” as the new owner of leftover “proxy sold” merchandise, the card-issuing merchant may make the “beneficiary” selection(s).

It is also another object of the present invention to provide a system and a method for the original owner of “proxy sold” merchant, to gain a tax benefit, when the ownership in the leftover “proxy sold” merchandise is transferred to a charitable institution(s).

It is also another object of the present invention to provide a system and a method for “beneficiaries” to register themselves as institutions interested in receiving donated “proxy sold” merchandise” from the original owners.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a block diagram of the components of a system operated by a merchant and a third party to allow a merchandise card system to make an initial “proxy purchase” followed by an adjusted “final purchase” of goods and/or service in accordance with the invention;

FIG. 2 is a block diagram of the components of a system fully operated by the merchant alone to allow a merchandise card to make an initial “proxy purchase” followed by an adjusted “final purchase” of goods and/or service in accordance with the invention;

FIG. 3 is a block diagram of the components of a system operated by a bank or a card association to allow a merchandise card to make an initial “proxy purchase” followed by an adjusted “final purchase” of goods and/or service in accordance with the invention;

FIG. 4A illustrates a financial transaction card incorporating mag stripe technology with a unique ID account number connecting to a cardholder's merchandise card account;

FIG. 4B illustrates a smart card incorporating integrated circuit technology to convey a unique ID account number connected to a cardholder's merchandise card account;

FIG. 4C illustrates a radio frequency device being used as the conveyor of a unique ID account number connected to a cardholder's merchandise card account;

FIG. 5 is a flowchart illustrating the process of opening a merchandise account that is immediately used to make a “proxy purchase” of goods and/or services in accordance with the invention;

FIG. 6 is a flowchart illustrating the process of loading or reloading cash into account that is immediately used to make a “proxy purchase” of goods and/or services in accordance with the invention;

FIG. 7 is a flowchart illustrating the process of a cardholder debiting their account. Here a cardholder can convert any part or percentage of their “total proxy purchases” of goods or services to a “final purchase” of goods or services.

FIG. 8 shows an example of a merchant card transaction in operation.

FIG. 9 is a block diagram of one of the embodiments of the invention, elements and stations of the system are composed of cardholders using cards, card issuing merchants and agents, a POS terminal, a default administrator with a list of registered default owner(s), card issuer merchant headquarters, and an account processor;

FIG. 10 is a flow chart illustrating a cardholder purchasing or reloading a merchandise card or debiting from a merchandise card, a cardholder or the card issuer selecting a beneficiary, and showing the distribution options when an account becomes terminated in accordance with FIG. 9;

FIG. 11 is a flowchart illustrating the process of a cardholder selecting the “beneficiary” in accordance with an embodiment of the invention in accordance with FIG. 9;

FIG. 12 is a flowchart illustrating the process of a card issuer selecting the “beneficiary” in accordance with an embodiment the invention in accordance with FIG. 9;

FIG. 13 is a flowchart illustrating the process of a “beneficiary organization” registering itself in accordance with an embodiment the invention in accordance with FIG. 9; and

FIG. 14 is a flowchart illustrating a version of the invention, showing the process of assigning leftover “proxy sold” merchandise as a donation to selected beneficiaries in accordance with FIG. 9.

Throughout the figures, unless otherwise stated, the same reference numerals and characters are used to denote like features, elements, components, or portions of the illustrated embodiments. Moreover, while the subject invention will now be described in detail with reference to the figures and in connection with the illustrative embodiments, changes and modifications can be made to the described embodiments without departing from the true scope and spirit of the subject invention as defined by the appended claims.

### DETAILED DESCRIPTION OF THE INVENTION

The invention describes a method and system for activating a merchandise card MC and a merchandise account MA that permits a cardholder CH to deposit cash into a merchandise account MA for the purpose of the cash being immediately used to purchase a percentage of the merchant's or card issuer's inventory, i.e. “proxy sold” merchandise.

After the transaction is completed the cardholder's merchandise card account will show a record of the transaction and the amount of cumulative inventory owned by the cardholder.

This purchasing transaction is called a proxy transaction PT because at the time of purchase the cardholder instructs the selling merchant or issuer to maintain possession of the inventory until a later time when the cardholder will return to make a final selection FS from the merchant's inventory.

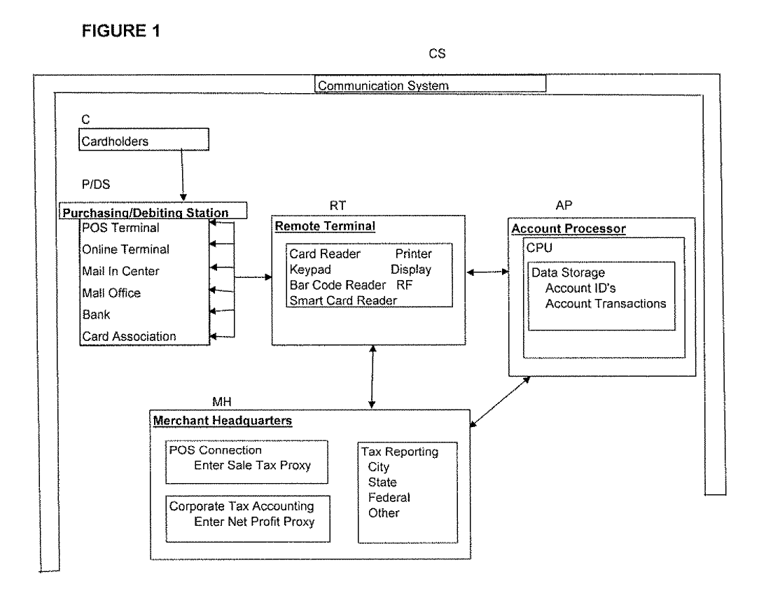

In order to effect the invention, the system requires a network of players, see FIG. 1 composed of cardholders, merchants, card issuers, processors, etc. who process transactions using remote terminals and central computers to load, reload, and debit against merchandise card accounts using the following stations (1) a purchasing/debiting P/DS station, (2) a merchant headquarters station MH, and (3) an account processor station AP.

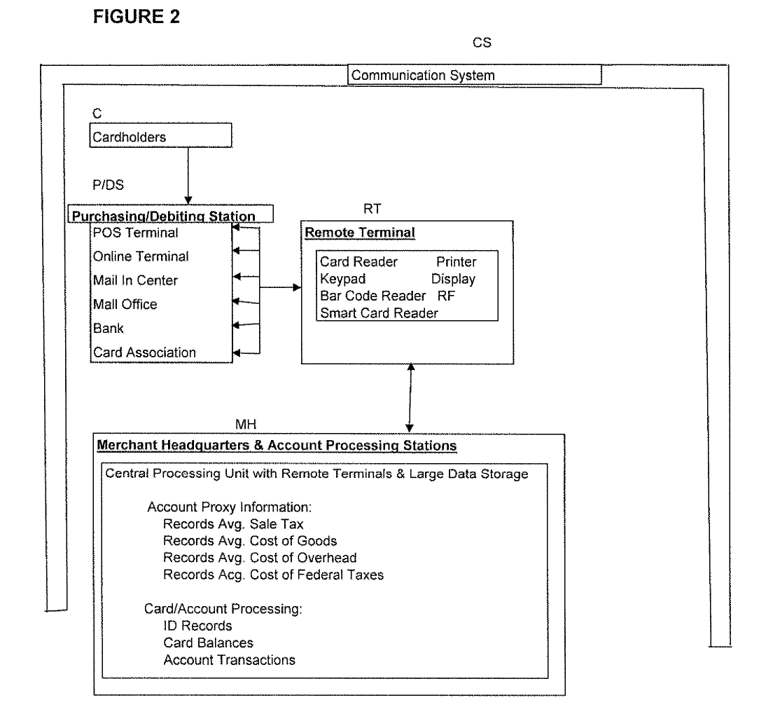

FIG. 2, shows the three stations in the network (P/DS, MH, AP) being operated by the merchant organization.

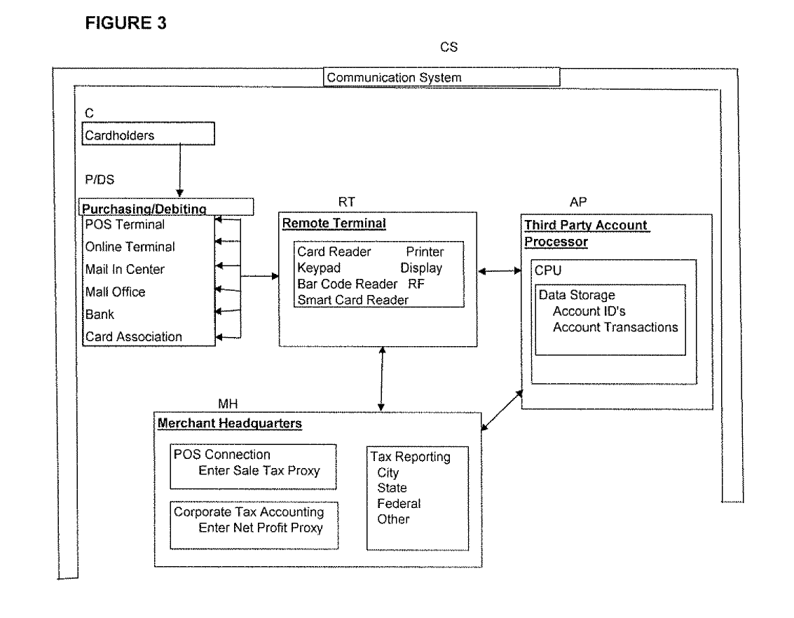

FIG. 3, shows a configuration of a bank or card association operating a central computer connected to customers and diverse merchants.

The commonality among all system configurations is the fact that the merchandise card account system MC is connected to card issuer locations or purchasing/debiting stations P/DSx that allow merchants and others to operate remote terminals RTx that in turn are connected to computers and networks located in merchant headquarters MH and an account processors AP.

Said remote terminals RTx are connected to merchant headquarters MH and account processor AP stations via a communication system CS. The CS may include telephone lines, satellites, RF frequency devices, or cables.

In the embodiment, purchasing/debiting stations P/DSx are equipped with remote terminals RTx composed of cash registers CRx or POS terminals POSx with keypads KPx, card readers CRx, bar code readers BCRx, printers Px, and display screens DSx to record the amount of merchandise being entered into a MC account.

Throughout this specification, the term x, when appended to the end of a reference character, is equal to 1, . . . M, . . . N.

Said P/DSx with RTx are located in point of sale merchant retail locations MRL, merchant online sales MOS facilities, direct mail sales DMS facilities, shopping mall offices SMO, bank locations B, and card association locations CA.

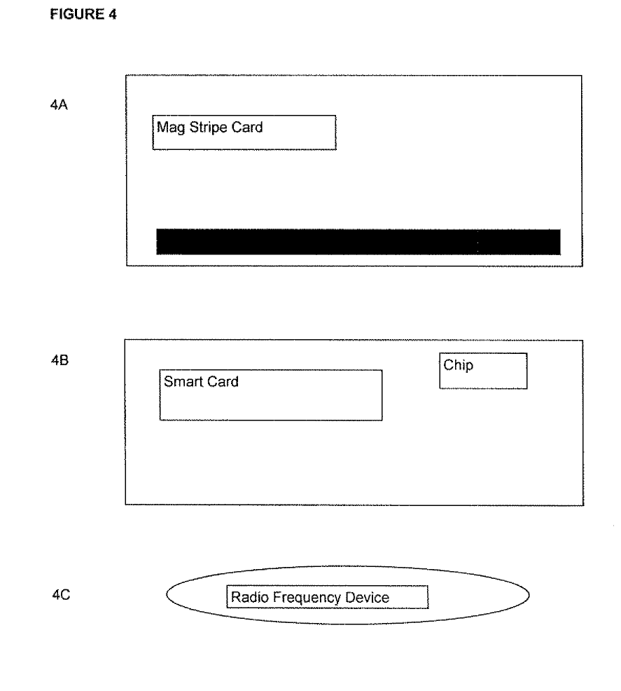

In said P/DSx locations, card issuers issue cards and accounts to customers with individual and distinct account identifiers. Once a customer has a card account, the customer can tender cash value to card issuers and the merchandise ownership will be entered into remote terminals as in FIG. 4 that shows the mag stripe cards MSC, smart cards SC, or radio frequency devices RFD for crediting to their MC accounts.

As FIG. 1 shows, after said card is entered into a remote terminal RT at a P/DS location, the RT connects with the merchant headquarters MH and the account processor AP who manages the MC account. When the RT connects with the computers and networks located at MH and the AP, the system captures the critical information needed to immediately convert the entered MC merchandise into an actual sale, albeit a proxy sale, of merchandise until a final sale is conducted at the time of account debiting.

Effectively, the proxy sale of merchandise has a customer buying a percentage of the merchant's existing inventory using a proxy sale method. The proxy sale represents a “stand in number” until the cardholder makes a final selection from the merchant's inventory. The proxy sale is conducted as an actual sale because when the cash value is entered into the MC account, the issuing merchant applies its average historical operational costs (i.e. sale taxes, cost of goods, overhead costs, and federal taxes) against the amount of cash value being entered into the MC account.

To use the system, customers contact merchants or card issuers and receive a card whereupon they initially load or reload merchandise (i.e. $10, $50, $100, etc.) into a merchandise card MC account.

Immediately upon loading merchandise into the MC account, the system converts the “in merchandise” into a qualified sale of merchandise using a “proxy purchase” algorithm.

In order to be booked as earned revenue from a sale of goods or services, the system allows merchants to effect the “proxy method” by calculating the appropriate deductions for sale taxes, cost of goods, overhead costs, and the cost of federal taxes in order to determine the merchant's retained earnings or after tax net profit.

Under the system, each respective merchant or card issuer will determine its own unique “proxy purchase” by inputting its average costs of sales taxes, goods, overhead, and federal taxes against its overall inventory. Merchants customarily keep such sale records as required by Generally Accepted Accounting Practices (GAAP) in their computer networks located at merchant headquarters MH.

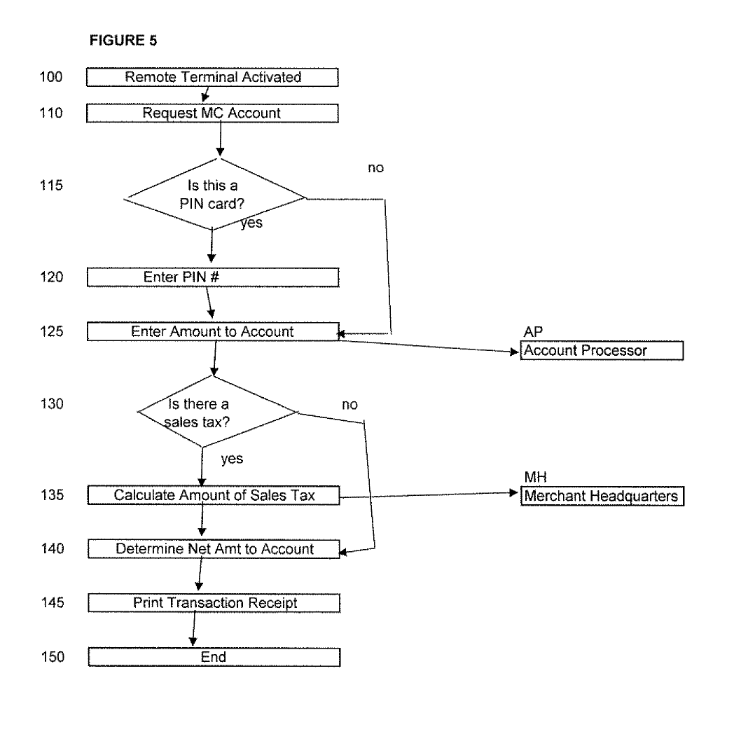

The system will now be described in more detail starting with references to FIG. 5, when a customer opens a merchandise card MC and an account.

In step 100, a remote terminal RT has been activated.

In step 110, a customer requests a MC account. Clerk swipes card through the remote terminal RT.

In step, 115 the computer asks if this is a PIN card (personal identification number)?

If the answer is yes, in step 120 the customer enters a PIN number into the terminal.

In step, 115 if the answer is no, the computer goes to step 125.

At step 125, the clerk or customer enters the amount of merchandise to be initially deposited to the MC account. The computer then connects with the central computer and database in the account processor AP station to report the card and account number, the PIN if there is one, and the amount of cash entered in step 125.

In step 130, the computer connects with the central computer and database in the merchant headquarters MH station, to lookup and asks if the merchant has assigned an average sales tax per dollar to its inventory.

If the answer is yes, in step, 135 the computer applies the sales tax percentage to the amount of cash entered to determine the amount of dollars to be sent to a state tax authority. The computer then goes to step 140.

If the answer is no, in step 140, the computer reports back to the merchant headquarters MC, the amount of sales taxes due produced in the proxy sale.

In step 145, the computer prints out a receipt.

In step 150, the computer returns to step 100 to await the next transaction.

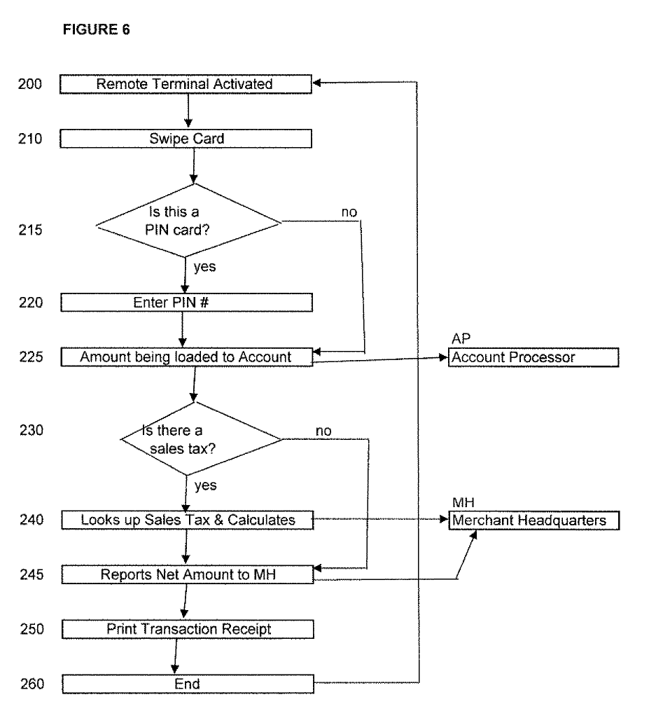

The system will now be described in more detail starting with references to FIG. 6, when a customer reloads their merchandise card MC and account.

In step 200, a remote terminal has been activated.

In step 210, a card is swiped through the terminal.

In step 215 the computer asks if this is a PIN card.

If the answer is no to step 215, the computer goes to step 225.

If the answer is yes in step 215, the computer goes to step 220 and the customer enters a PIN number into the terminal. The compute then goes to step 225.

At step 225 the computer asks how much is being loaded into the MC account. Once the amount is entered, the computer goes out to the Account Processor AP to report the amount of cash value going in to the MC account.

In step 230, the computer asks is there a sales tax?

If the answer to step 230 is yes, at step 240 the computer goes to the merchant headquarters MH and looks up the proxy sales tax and calculates the amount of sales tax.

In step 245 the computer reports the amount of sales tax and the net amount to merchant headquarters MH.

If the answer is no to step 230, the computer goes to step 245, and the computer reports the net amount to merchant headquarters MH.

In step 250, the computer prints out a receipt.

In step 260, the computer returns to step 200 to await the next transaction.

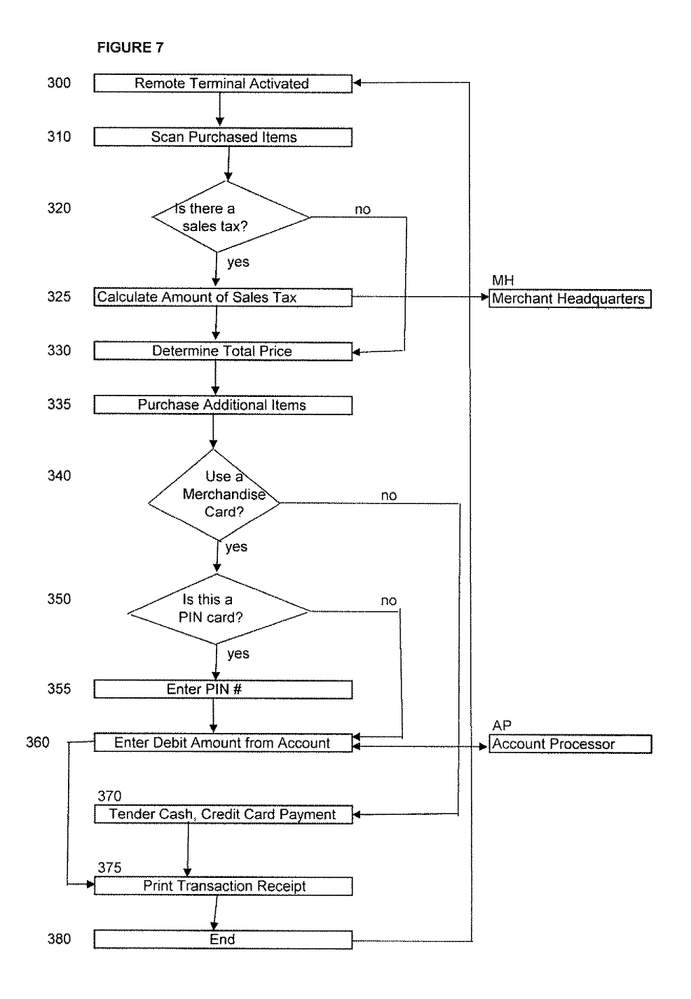

The system will now be described in more detail starting with references to FIG. 7, when a customer uses their merchandise card MC and account to make a debit.

In step 300, a remote terminal has been activated.

In step 310, the computer scans the bar code on an item to be purchased.

In step 320 the computer asks if there is a sale tax on the item.

If the answer is yes, in step 325 the computer looks up the sales tax percentage at merchant headquarters MH and calculates the amount of sales taxes.

In step 330, the computer totals the price of the item and the sales tax.

In step 335, the computer repeats steps 310 to 330 if additional items are being purchased.

In step 340, the computer asks if the customer wants to use a MC card/account.

If the answer is yes, in step 350, the computer asks if the MC card has a PIN number.

If the answer to step 350 is yes, in step 355 the computer requests the PIN.

In step 360, the computer displays the amount to be debited off the MC account and asks the cardholder to approve the debit from their account. The computer goes to the account processor AP station to gain acknowledgement that the merchandise are available and the AP computes a new MC card account balance.

If the answer to step 340 is no, in step 370, the computer asks for payment in cash, credit card, ATM card,

In step 375, the computer prints out a receipt.

In step 380, the computer returns to step 300.

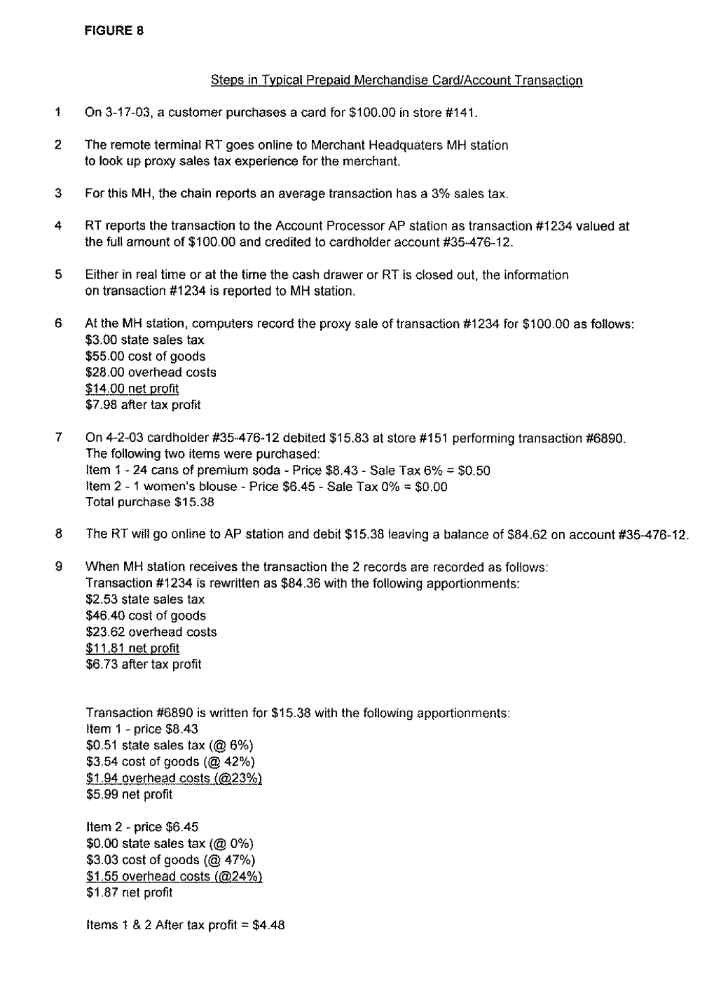

FIG. 8 shows a list of steps 1 to 9 in a typical merchant card transaction both merchandise in and merchandise out. The following is a hypothetical example of a MC transaction in a convenience store.

In step 1, said POS transaction, #1234, was completed on Mar. 17, 2003 in store #141. The transaction was for $100.00 to go to a gift merchandise account #35-476-12.

The hypothetical store is 1 of the 1,400 stores operated by the chain owner. In step 2 3, the remote terminal RT went online to the chain's headquarters MH, to determine the average sales tax for its transactions was 3%.

In step 4, the RT would go online to the Account Processor AP and record a $100 to account #35-476-12.

In step 5, the RT goes to MH and in step 6, transaction #1234 would show the following accounting: $3.00 due the state, $55.00 cost of goods, $28.00 for business overhead, $6.02 to IRS and $7.98 as after tax net profit to the convenience chain.

As long as transaction #1234 would stay as originally processed, the “proxy” information in the MH would be recorded as the details behind a final sale.

However in step 7, cardholder #35-476-12 went to store #151 and in transaction #6890 the customer debited $15.38 resulting in step 8 9 producing the following records at Merchant Headquarters:

On Apr. 2, 2003 cardholder #35-476-12 debited $15.83 at store #151 performing transaction #6890.

The following two items were purchased:

Item 1—24 cans of premium soda—Price $8.43—Sale Tax 6%=$0.50

Item 2—1 women's blouse—Price $6.45—Sale Tax 0%=$0.00

Total purchase $15.38

The RT will go online to AP station and debit $15.38 leaving a balance of $84.62 on account #35-476-12.

When MH station receives the transaction the 2 records are recorded as follows:

Transaction #1234 is rewritten as $84.36 with the following apportionments:

$2.53 state sales tax

$46.40 cost of goods

$23.62 overhead costs

$11.81 net profit

$6.73 after tax profit

The debited final sale transaction #6890 is written for $15.38 with the following apportionments:

Item 1—price $8.43

$0.51 state sales tax (@ 6%)

$3.54 cost of goods (@ 42%)

$1.94 overhead costs ((@ 223%)

$5.99 net profit

Item 2—price $6.45

$0.00 state sales tax (@ 0%)

$3.03 cost of goods (@ 47%)

$1.55 overhead costs (@ 24%)

$1.87 net profit

Items 1 & 2 After tax profit=$4.48

Once steps 1-9 are taken the system has completed its cycle.

In accordance with another embodiment of the invention, at the time of issuance, cardholders can instruct the issuing merchant to convert any unused “proxy sold” inventory as “proxy sold merchandise” to be recorded in a beneficiary accounts owned by new parties, i.e. nonprofits. When a beneficiary wishes to debit from their account, they will order merchandise cards from the Merchant Headquarter 125, 3^{rd} Party Account Processors 130, or the Beneficiary Administrator 115.

As another embodiment, when the original cardholder does not designate a beneficiary, the card issuing merchant may select a qualifying nonprofit.

Therefore, the invention provides the cardholder with the first right to make a decision of the “beneficiary” and if the cardholder does not make a “beneficiary” selection, the issuing merchant would make the choice of the “beneficiary”.

Under most circumstances, the beneficiary of the merchandise is a nonprofit organization that is an IRS recognized 501(c) Corporation. Upon request, if a cardholder's leftover “proxy sold” merchandise is donated to a nonprofit, the system will provide the original cardholder with a receipt for tax purposes.

As an alternative to the “beneficiary” being an IRS recognized nonprofit, it is possible under another embodiment of the system, that the “beneficiary” could be another individual named by the cardholder.

As another embodiment of the invention, a merchant may offer a merchandise card program that does not provide an option to cardholders, but instead automatically converts ownership in leftover “proxy purchased” merchandise to one or more “beneficiaries”. Under such a program, merchants will advise cardholders—in advance—that if the cardholder ceases to conduct transactions over a period of time or the card has a conversion date, any leftover “proxy sold” merchandise will be assigned to the new owner/beneficiary.

As another embodiment of the invention, once the events leading to conversion of leftover “proxy sold” merchandise are triggered off and if the named “beneficiary” cannot be located or fails to perform by ordering or selecting merchandise from the issuing merchant under certain time deadlines, the system will be equipped to make substitute “beneficiary” selections until the performance requirements are met by a new “beneficiary”.

In another embodiment of the invention, when a nonprofit “beneficiary” registers with the “beneficiary administrator” and is accepted in the system, the nonprofit beneficiary may ask their supporters to list them as their “beneficiary”.

In addition to earning the right to be the “beneficiary”, in another version of the invention, registered “beneficiaries” could become card issuing agents for singular merchants or multiple merchants (as in malls).

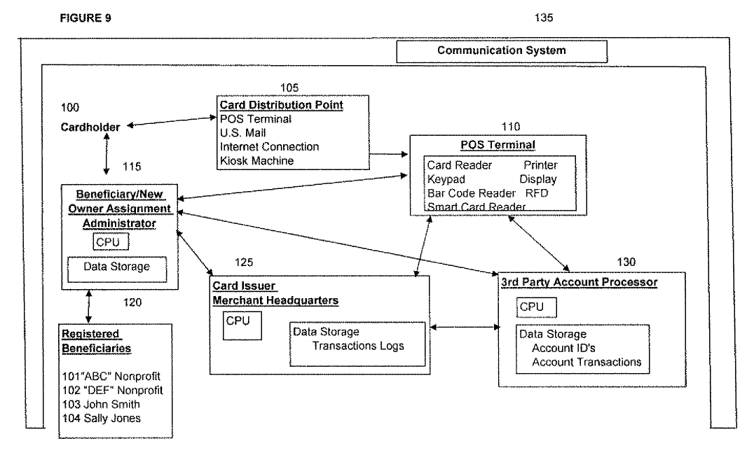

By way of introduction to the details in the system, FIG. 9 shows a block design of the following seven elements in the system as follows; cardholder 100, card distributor point 105, merchant POS (Point of Sale) terminal 110, beneficiary administrator 115, registered beneficiaries 120, card issuer merchant headquarters 125, account processor 130, and a communication system 135.

In the preferred embodiment, FIG. 9 shows a cardholder 100, who may be the initial purchaser or a recipient of the card, obtaining a merchandise card at the card distributor level 105, by selecting a card from a display rack, asking a clerk for a card, receiving a card in the mail, from a dispensing machine, or any other means. Once the cardholder has the card, it is scanned in a card reader and the cardholder 100 enters their initial proxy purchase amount (e.g., $5.00, $20.00, $50.00 or any amount) or reloads a proxy purchase of any amount into the issuing merchant's POS terminal 110. The POS terminals 110 located in issuing merchant locations may be cash registers, connected to respective keypads, and card readers. Each cash register, keypad and card reader connected to each other represents a remote terminal.

As another option in this embodiment, the merchandise card issued to the cardholder can be protected by PIN or operated without a PIN number. If a PIN is required the number can be acquired at the merchant POS terminal 110, online, through a telephony set up, or by any other means.

At the merchant POS terminal 100, the cardholder can also instruct the issuing merchant to convert any leftover “proxy sold” merchandise in their account to be donated to the one or more beneficiaries that they select. To initiate this option, the cardholder (or the store clerk) scans the card again and keystrokes in the selected beneficiary's identification number from a list of registered beneficiaries provided by the merchant at the point of sale counter.

As an alternative to selecting one or more beneficiaries at a POS terminal 110, other remote terminals can connect with the computers in the Beneficiary Administrator 115. The alternate remote terminals station can be personal computers, Internet devices, PDA, cell phones, POTS lines, or any other device capable of interacting with the Beneficiary Administrator 115.

After recording this information, the merchant POS terminal reports the cardholder's instructions to the beneficiary administrator 115, the selected registered beneficiaries 120, and depending on the set up of the elements in FIG. 9, card issuing merchant headquarters 125 and/or the account processor 130 will also receive the information.

When the information is received at merchant headquarters and/or the account processor, the computer systems in either or both locations will determine when a merchandise card account is close to having its left over “proxy sold” merchandise donated to a beneficiary. The parameters that will determine when to donate “proxy sold” merchandise to a nonprofit can be (a) a specific date, (b) a time of non card usage, (c) a date determined by the merchant/cardholder, and/or (d) any other specified circumstance.

Based upon this information, the computers in the card issuing merchant headquarters 125 and/or the account processor 130 will be downloaded with the needed parameters to determine when merchandise in any one account will be converted as a donation of “proxy sold” merchandise to a designated beneficiary. Once the logic is programmed into the respective computers, the daily processing of transactions will set off flags indicting the card number to be converted, the state where the card was sold, the balance on the account, and the need to send notice to the selected beneficiaries that “proxy sold” merchandise is now under the beneficiary's ownership, and said “proxy sold” merchandise can now be issued in the form of new cards to the selected beneficiary.

In addition to the option of cardholders enrolling at the merchant POS terminals 110, cardholders also have the opportunity to make their beneficiary selections at a later time by using a personal computer, Internet device, telephonic connection, remote terminal, or any other device capable of sending the computers in the beneficiary administrator 115 and/or the registered beneficiaries 120.

After the cash is accepted at a merchant location, the POS terminal 110 sends cash to card issuing merchant headquarters 125 and the data on the card transaction is sent on a real time or batch basis to the account processor 130.

As one of the embodiments, the account processor 130 maintains the accounting record for each “proxy sold” purchase and debit connected to each merchandise card. The account processor also reports back to the merchant POS terminal 110 whenever a “proxy sold” purchase or debit transaction is performed. The merchant POS terminal then prints out a receipt for the cardholder showing the amount of the “proxy sold” purchase or debit, as well as provides an updated report on the balance in the cardholder's account.

Also in FIG. 9, there is a communication system 135 that may include telephone lines, satellites, radio frequency devices, or cables that connects the various elements and components of the system in an orderly and efficient basis.

As alternative embodiments of the invention, it is also possible that the functioning of beneficiary administrator 115 and registered beneficiaries 120 could be housed and operated by the computers in the card issuing merchant headquarters 125 station and/or the account processor 130 station.

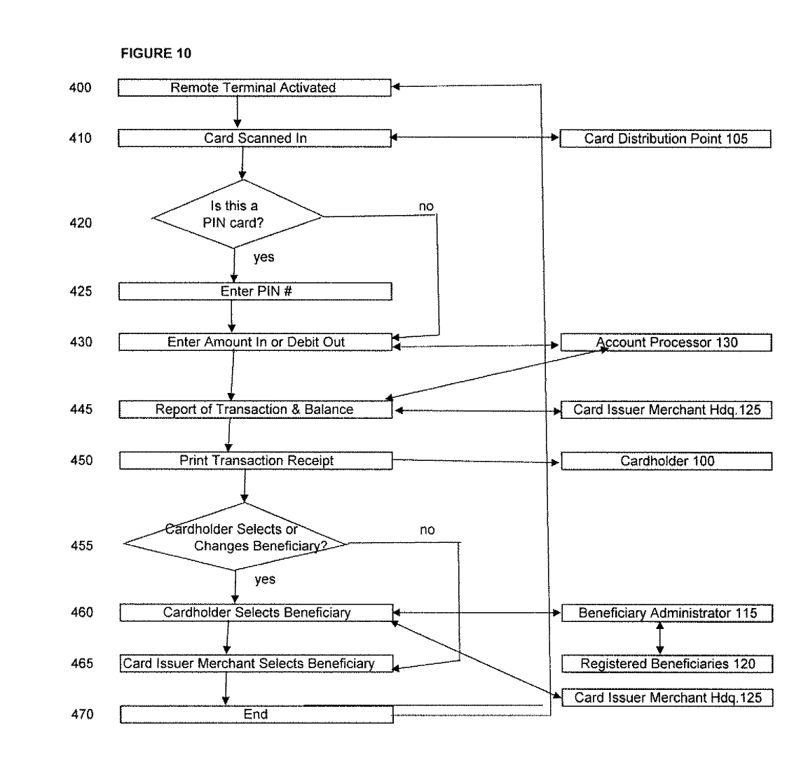

FIG. 10 is a flowchart illustrating the process of a cardholder opening, reloading, or debiting a merchandise card at POS terminal 110, as well as a cardholder 100 or card issuing merchant headquarters 125 selecting a beneficiary, and showing the options on how leftover “proxy sold” merchandise can be distributed when an account becomes terminated in accordance with FIG. 9.

The system will now be described in more detail starting with references to FIG. 10, when a customer opens a merchandise card MC and an account.

In step 400, a remote terminal RT has been activated.

In step 410, a customer requests a MC account. Clerk swipes card through the remote terminal RT.

In step, 420 the computer asks if this is a PIN card (personal identification number)?

If the answer is yes, in step 425 the customer enters a PIN number into the terminal.

In step, 420 if the answer is no, the computer goes to step 430.

At step 430, the clerk or customer enters the amount of merchandise to be initially deposited to the MC account. The computer then connects with the central computer and database in the account processor AP station to report the card and account number, the PIN if there is one, and the amount of cash entered in step 430.

In step 445, the computer connects with the central computer and database in the merchant headquarters MH station, to lookup and report if the merchant has assigned an average sales tax per dollar to its inventory.

In step, 430 the computer applies the sales tax percentage to the amount of cash entered to determine the amount of dollars to be sent to a state tax authority.

In step 445, the computer reports back to the merchant headquarters MC, the amount of sales taxes due that was produced in the proxy sale, thus determining the net amount of the proxy purchase to the cardholder's account.

In step 455, the computer asks if the cardholder has selected a beneficiary.

In step 460, if the answer is yes, the computer accepts the name of the beneficiary selected by the cardholder.

In step 465, if the answer is no, the computer accepts the name of the beneficiary selected by the merchant.

In step 450, the computer prints out a receipt.

In step 470, the computer returns to step 400 to await the next transaction.

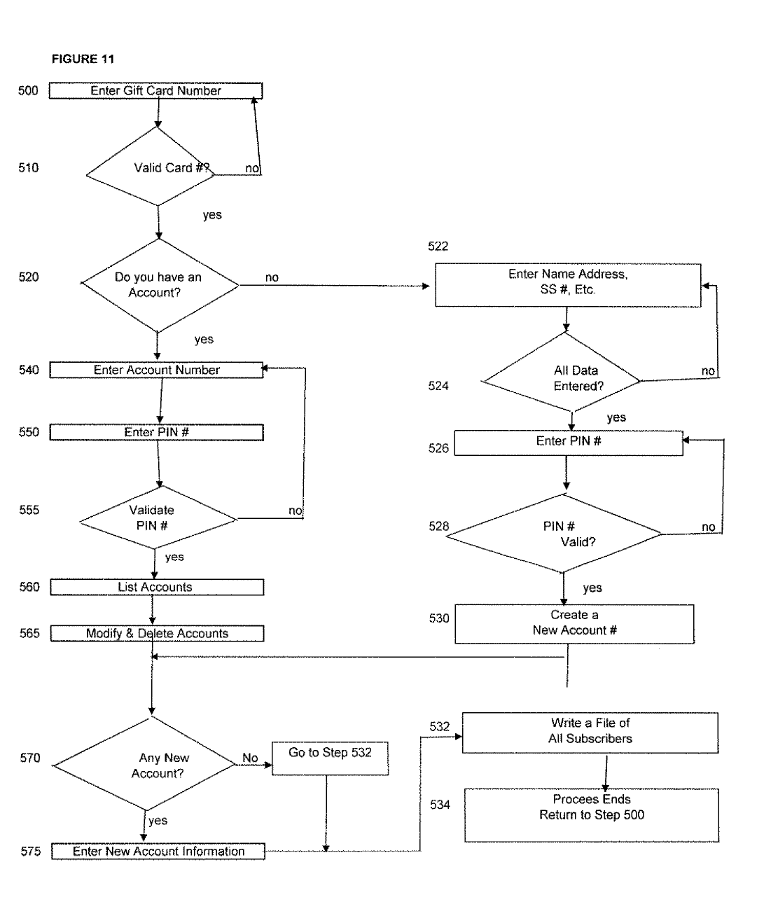

FIG. 11 is a flow chart, which illustrate the steps that the Beneficiary Administrator 115 requires of a “proxy sold” cardholder in order to select one or more beneficiaries from a list of a Registered Beneficiaries 120 or to name another beneficiary not on the list. To make an initial selection or revise a previous selection, a cardholder may enter the required information at a merchant POS terminal 110 or any other remote terminal that connects with the Beneficiary Administrator 115. The other remote terminals that connect to the computers in the Beneficiary Administrator 115 station may be personal computers, Internet devices, PDA, cell phones, POTS lines, or any other device capable of interacting with the Beneficiary Administrator 115.

After the cardholder has accessed the Beneficiary Administrator 115 computer via a POS or remote terminal, the computer, in step 500, asks the cardholder to first enter their “proxy sold” merchandise card number. In step 510 the computer goes to the Account Processor 130, to see if this is a valid card number. If the card number is not a valid card number, the computer returns to step 500 and asks for a valid card number.

If yes, the card is valid, at step 520 the Beneficiary Administrator asks if they already have a “beneficiary account” number. If not, in step 522, the computer in the Beneficiary Administrator 115 asks the cardholder to enter his or her name or address. In step 524, the computer asks if all information has been entered. If not, it returns to step 522 to ask again for the desired information. If yes, the computer proceeds to step 526 to ask the cardholder to choose a personal identification (PIN) number to protect their “beneficiary account”. In step 528, the computer determines if the PIN number is acceptable. If not it returns to step 526 for another number. If yes, the computer advances to step 530 to assign a new “beneficiary account” number.

If the answer in step 520 is yes, that the consumer has a “beneficiary account” number, the computer proceeds to step 540 to have the customer enter their beneficiary account number. In step 550, it asks the consumer to enter his or her preselected PIN number. In step 555 it determines whether the entered PIN number matches the preselected PIN number. If not, it returns to step 550 for a corrected number. The computer allows this procedure between steps 550 and 555 recur only a predetermined number of times. Thereafter it aborts the program.

If the PIN number is correct and thereby qualified, the computer, in step 560 lists all of the cardholder's previously selected “registered beneficiary selections” and the merchandise card numbers associated with the selections, both nonprofits and individual names. The computer also lists the amount of leftover “proxy sold” merchandise previously converted to “proxy sold” merchandise card and donated to registered beneficiary during any specific time period, such as the calendar year. The consumer may request any time period.

In step 560, it also lists all selected beneficiaries and the leftover “proxy sold” merchandise card account numbers that will be soon converted to a “proxy sold” merchandise card for the beneficiaries. In step 565 it asks the cardholder if they wish modify or delete an account, if any.

In step 570, the computer asks if there are any new beneficiary account selections and “proxy sold” merchandise card numbers. If yes, in step 575 the computer asks the cardholder to enter the new “proxy sold” merchandise card number and match it with one or more beneficiary selections from list of Registered Beneficiaries 120 held in memory in the Beneficiary Administrator's 115 database. If the answer is no, the computer, goes to step 532 and updates the file of all beneficiary selections and “proxy sold” merchandise card account numbers.

If the answer to step 570 is yes, the computer in step 575 asks the cardholder to enter the new beneficiary name and number, as well as the associated “proxy sold” merchandise card number. The computer then goes to step 532 to update the file of all beneficiaries and their “proxy sold” card accounts. In step 534 the computer returns to step 500.

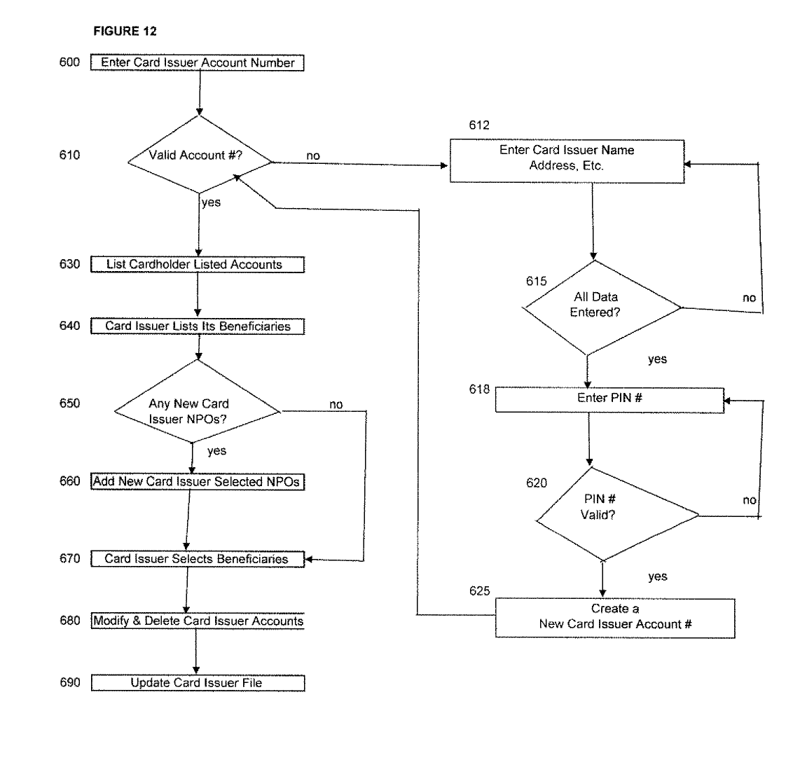

FIG. 12 is a flowchart illustrating the process of a Card Issuer Merchant Headquarters 125 connecting with the Beneficiary Administrator 115 “beneficiary” in accordance with an embodiment of the invention in FIG. 9.

Here, the Beneficiary Administrator 115 requires a PIN number from a card-issuing merchant. Once in the Beneficiary Administrator 115 computer systems, the card-issuing merchant can receive reports showing the identity of all cardholders who have selected one or more beneficiaries to receive their leftover merchandise in the form of a merchandise donation and their matching gift card numbers. The Card Issuer Merchant Headquarters 125 can also register its favorite nonprofit organizations (NPO) as registered beneficiaries in the Beneficiary Administrator 115 database. The Beneficiary Administrator 115 will also provide card issuers with a report of the issued “proxy sold” merchandise card numbers that do not have donation instructions from cardholders or their recipients. Under such circumstances, the Beneficiary Administrator 115 will provide the card-issuing merchant the opportunity to make one or more nonprofit beneficiary selections in behalf of the cardholders.

After a card-issuing merchant accessed the Beneficiary Administrator 115 computer via a POS or remote terminal, the computer, in step 600, asks the card-issuer to first enter their account number. In step 610, the computer asks if the entered account number is a valid account number.

If the number is not valid, the computer goes back to step 612 and has the card issuer provide the needed information to open an account. In step 615 the computer determines if the needed data has been entered. If the answer is no, the computer goes back to step 612 to obtain the needed information. If the answer is yes, in step 618 the card issuer enters a PIN number. If the number is declined at step 620, the computer returns to step 618 for a new PIN number. If the answer to step 620 is yes, the computer goes to step 625 and creates a new card issuer account with or without a PIN number. Step 625 then reports to step 610 and the new account number becomes a valid account number in the database of the Beneficiary Administrator 115 computers.

In step 610, if answer is yes, the computer goes to step 630 and displays all cardholder predetermined beneficiary accounts showing the identity of the cardholder, the “proxy sold” merchandise card number, and one or more beneficiaries named by the cardholder. The named beneficiaries can be, for example, 501(c) Corporations or individuals who might be friends or relatives of the cardholder.

In step 640, the Beneficiary Administrator 115 computer lists the favorite nonprofit organizations previously selected by the Card Issuer 125.

In step 650, the Beneficiary Administrator 115 computer asks the Card Issuer 125 if it wishes to register any new nonprofit organizations. If the answer is yes, the computer goes to step 660 and enters the new nonprofit entries. If the answer is no, the computer goes to step 670.

In step 670, the Beneficiary Administrator 115 computer allows the Card Issuer 125 to select any nonprofits from its list and matches the selected nonprofits with the “proxy sold” merchandise card accounts that do not have a listed beneficiary.

In step 680, the computer modifies and deletes any nonprofit selected by the Card Issuer 125. In step 690, the Beneficiary Administrator 115 updates the card issuer's nonprofit file.

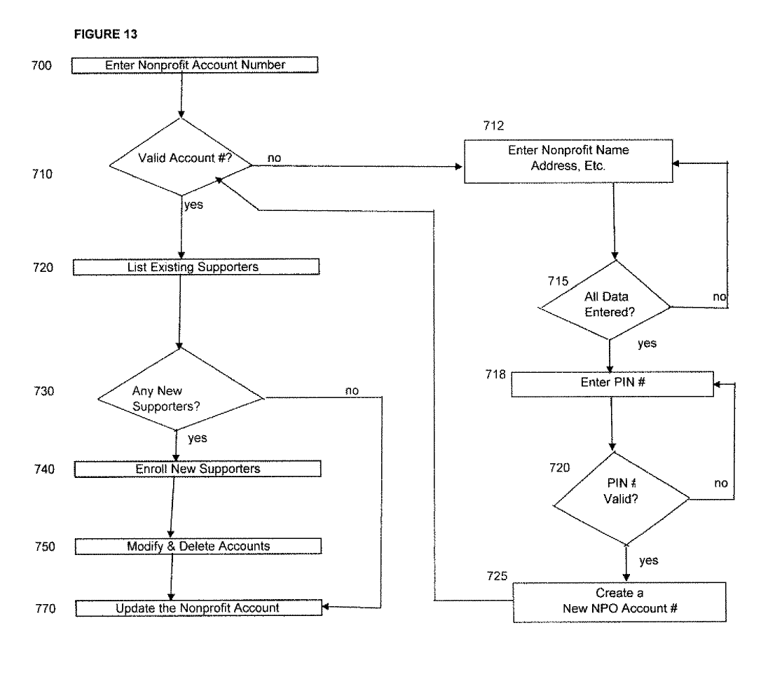

FIG. 13 is a flowchart illustrating the process of a Registered Beneficiary 120 (a qualified nonprofit organization) registering with the Beneficiary Administrator 115 in accordance with an embodiment of the invention in FIG. 9.

Here the Beneficiary Administrator 115 requires a PIN number from a Registered Beneficiary 120. Once in the Beneficiary Administrator 115 computer systems, the Registered Beneficiary 120 can register itself as a nonprofit that wishes to be listed as a registered beneficiary. by cardholders, its supporters, and the card issuing merchants, as the selected beneficiary of “proxy sold” merchandise contributions.

After a nonprofit (a Registered Beneficiary 120) accessed the Beneficiary Administrator 115 computer via a POS or remote terminal, the computer, in step 700, asks the nonprofit to first enter their account number. In step 710, the computer asks if the entered account number is a valid account number. If the number is not valid, the computer goes to step 712 and has the nonprofit provide the needed information to open an account. In step 715 the computer determines if the needed data has been entered. If the answer is no, the computer goes back to step 712 to obtain the needed information. If the answer is yes, in step 718 the nonprofit enters a PIN number. If the number is declined at step 720, the computer returns to step 718 for a new PIN number. If the answer is yes, to step 720, the computer goes to step 725 and creates a new nonprofit account with or without a PIN number. Step 725 then reports to step 710 and the new account number becomes a valid account number in the database of the Beneficiary Administrator 115 computers.

In step 710, if answer is yes, the computer goes to step 720 and displays all existing supporters, who as a “proxy sold” merchandise cardholder, have selected the nonprofit as its choice to receive donated “proxy sold” merchandise.

In step 730, the Beneficiary Administrator 115 computer asks the nonprofit if it wishes to register any new supporters. If the answer is yes, the computer goes to step 740 and the nonprofit enters the identity of new supporters and their card numbers. In step 750, the computer modifies and/or deletes any of the nonprofit's supporter accounts. In step 770, the computer updates all information on the nonprofit organization. If the answer is no, to step 730, the computer goes directly to step 770.

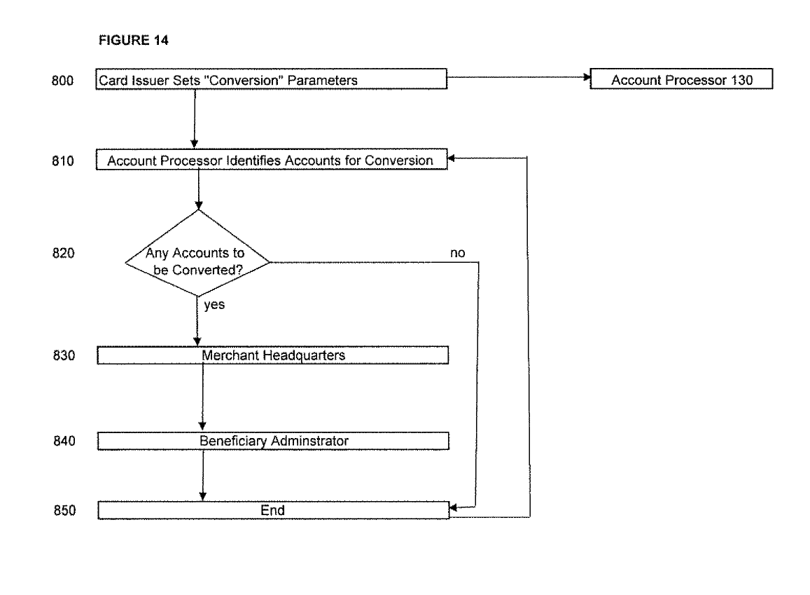

FIG. 14 is a flowchart illustrating the process of Card Issuer Headquarters 125 setting “donating” parameters, the Account Processor 130 identifying “proxy sold” card accounts for donation, and the communication from the Card Issuer Headquarters 125 to the Beneficiary Administrator 115 that one or more Registered Beneficiaries 120 should be receiving “proxy sold” merchandise from the Card Issuer Headquarters 125 in accordance with an embodiment of the invention in FIG. 9.

In step 800, the computer asks decision makers in Card Issuing Merchant Headquarters 125 enter data citing when the “proxy sold” merchandise is to be donated. The information entered determines the “donation parameters”. The date for donation can be based upon the number of days from the time the card was initially purchase, the number of days when the card was lasted used in a POS terminal 110, or any trigger parameter. The “donation parameters” information is also forwarded to Account Processor 130.

In step 810, the computer in the Account Processor 130 runs routines to identify the “proxy sold” merchandise card accounts that fall within the “donation parameters”.

In step 820, the Card Issuing Merchant Headquarters 125 queries the Account Processor 130 to see if there are any accounts to be converted.

In step 820, if the answer is no, the computer goes to step 850 the end.

If the answer to step 820 is yes, information on the accounts are returned to Card Issuing Merchant Headquarters 125 at step 830.

At step 830, the computer at Card Issuing Merchant Headquarters 125 sends the Beneficiary Administrator 115 the list of the account numbers and/or beneficiaries in 120 who are eligible to receive “proxy sold” merchandise donations.

At step 840, the Beneficiary Administrator 115 advises the individual beneficiaries that they now own “proxy sold” merchandise. The Card Issuing Merchant Headquarters 125 will periodically send “proxy sold” merchandise cards to qualifying beneficiaries.

At step 850 the programs terminates.

A feature provided by the invention is that when a customer purchases a “proxy sold” merchandise card, the merchant has a completed sale that can be immediately booked as revenue.

Under the invention “a merchant's sale is a 100% sale”.

Another feature is that merchant will not need to deal with state “escheatment” authorities.

Another feature lies in the fact that the customer immediately own merchandise, therefore, if a merchant goes bankrupt the customer's ownership remains outside of the control of the creditors.

Another feature of the invention is that city, state, and federal tax authorities will receive taxes on 100% of the sale.

Another feature is that if the customer should lose their card, forget to use all of the merchandise on their card, or hold the card past a prescribed expiration date, they can still benefit by knowing that their unused “proxy sold” merchandise can be donated to the selected nonprofit(s).

Although the present invention has been described with reference to certain preferred embodiments, various modifications, alterations, and substitutions will be known or obvious to those skilled in the art without departing from the spirit and scope of the invention, as defined by the appended claims.

I claim:

1. A method for converting customer owned merchandise to ownership by a beneficiary involving a merchant, a merchandise cardholder, and a beneficiary, said method comprising:
selecting one or more beneficiaries that are to own the merchandise, the merchandise being issued by the merchant;
associating the one or more beneficiaries with a customer merchandise account, wherein the one or more beneficiaries differs from the customer, the customer merchandise account having a remaining balance of merchandise owned by the customer;
automatically converting an amount of the customer owned merchandise based on a triggering parameter, to ownership by the one or more beneficiaries; and
transferring ownership of the merchandise to the selected one or more beneficiaries.

2. The method of claim 1, wherein the one or more beneficiaries are selected from one of charities, individuals, and a combination thereof.

3. The method of claim 1, further comprising allowing the customer merchandise owner to select the one or more beneficiaries.

4. The method of claim 1, wherein merchandise issuing merchant selects the one or more beneficiaries.

5. The method of claim 1, wherein the selected beneficiary is a nonprofit.

6. The method of claim 1, wherein associating the one or more beneficiaries takes place when the merchandise account is opened.

7. The method of claim 1, wherein associating the one or more beneficiaries takes place when the merchandise account is reloaded.

8. The method of claim 1, wherein associating the one or more beneficiaries takes place using a remote terminal when the merchandise account is not being loaded or reloaded.

9. The method of claim 1, further comprising modifying which beneficiaries are the one or more default beneficiaries.

10. The method of claim 1, wherein converting the amount of remaining merchandise is a conversion of the remaining balance of the merchandise account.

11. A system for converting customer owned merchandise, said system comprising:
a database for associating one or more beneficiaries with a merchandise card account, the one or more beneficiaries selected by the cardholder, wherein the one or more beneficiaries differs from the merchant cardholder, the merchandise card account having a remaining balance of merchandise owned by the cardholder;
a storage device for storing a trigger parameter; and
at least one processor for determining when to automatically convert an amount of the remaining merchandise based on the triggering parameter and for transferring ownership of the merchandise to the one or more beneficiaries wherein the converting comprises recording by a merchant of the amount of merchandise being donated to the new owner.

12. The system of claim 11, wherein the one or more beneficiaries comprises beneficiaries selected from one of charities, individuals, and a combination thereof.

13. The system of claim 11, further comprising input means for allowing a holder of the merchandise card account to select the one or more beneficiaries.

14. The system of claim 11, further comprising input means for allowing a card-issuing merchant to select the one or more beneficiaries.

15. The system of claim 11, further comprising input means for allowing a nonprofit to be select as the beneficiary.

16. The system of claim 11, further comprising a card distribution point at which one or more beneficiaries is associated with the merchandise card account when it is opened.

17. The system of claim 11, further comprising a card distribution point at which one or more beneficiaries is associated with the merchandise card account when it is reloaded.

18. The system of claim 11, further comprising a remote terminal at which one or more beneficiaries is associated with the merchandise card account when the merchandise card account is not being loaded or reloaded.

19. The system of claim 11, wherein the database is modified with respect to which beneficiaries are the one or more beneficiaries.

20. The system of claim 11, wherein the amount of the remaining balance of merchandise on the card comprises the remaining balance of the cardholder owned merchandise.
